(19) United States
(12) Patent Application Publication
(10) Pub. No.: US 2013/0264309 A1
(43) Pub. Date: Oct. 10, 2013

(54) ACOUSTIC ENERGY UTILIZATION IN PLASMA PROCESSING

(71) Applicants: Ian J. Kenworthy, Campbell, CA (US); Daniel A. Brown, Brentwood, CA (US); Cliff E. La Croix, Livermore, CA (US); Josh A. Cormier, Los Gatos, CA (US)

(72) Inventors: Ian J. Kenworthy, Campbell, CA (US); Daniel A. Brown, Brentwood, CA (US); Cliff E. La Croix, Livermore, CA (US); Josh A. Cormier, Los Gatos, CA (US)

(21) Appl. No.: 13/440,884

(22) Filed: Apr. 5, 2012

(51) Int. Cl. H05H 1/24; B44C 1/22

(52) U.S. Cl. 216/67; 156/345.33

(57) ABSTRACT

Methods and apparatus for processing a substrate using plasma are disclosed. The apparatus includes a plasma processing system having a process gas supply arrangement for supplying a process gas into an interior region of said chamber and a plasma source configured for generating said plasma at least from said process gas. The apparatus also includes an acoustic energy generator arrangement configured to apply acoustic energy to at least one of a chamber component and said substrate, wherein said acoustic energy generator generates said acoustic energy in the range of 10 Hz to 1 MHz using at least one of a piezoelectric transducing, mechanical coupling vibration, wafer backside gas pulsing, pulsing of said process gas, pressure wave pulsing, and electromagnetic coupling.

### BACKGROUND OF THE INVENTION

Plasma has long been employed for processing substrates (e.g., wafers, flat panel displays, liquid crystal displays, etc.) into electronic devices (e.g., integrated circuit dies) for incorporation into a variety of electronic products (e.g., smart phones, computers, etc.).

In plasma processing, a plasma processing system having one or more plasma processing chambers may be employed to process one or more substrates. In each chamber, plasma generation may employ capacitively coupled plasma technology, inductively coupled plasma technology, electron-cyclotron technology, microwave technology, etc.

As circuit geometries become smaller and customer requirements for etch profiles, etch selectivity, and other etch parameters become more stringent, certain substrate processing applications have required increased energy input in order to achieve the increasingly stringent processing requirements of modern electronic devices. As an example, greater etch depth and reduced etch time (driven by economic considerations) have both required a greater level of input RF power.

In some cases, it may be possible to simply increase the RF power level to achieve these advanced processing results. Unfortunately, increasing the RF power levels also leads to increased thermal loading on the substrate and/or on components of the plasma processing system. The increased thermal loading requires complicated and/or expensive heat removal arrangements and/or exotic materials that are more thermally stable and can withstand the increased thermal loading. All these considerations add complexity and cost to plasma processing.

Increasing the RF power level also increases the possibility of collateral damage. For example, arcing and bombardment issues become more pronounced at higher RF power levels. At higher RF power levels, consumable parts require replacement more often due to increased wear due to, for example, ion bombardment damage. In some cases, the collateral damage to the substrate and/or chamber components severely limit the amount of RF power that can be employed, thereby severely restricting the process window and increasing the cost of consumables.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with one or more embodiments of the invention, the use of a piezoelectric transducer to provide acoustic energy, directly or indirectly via one or more intermediate components, to the substrate.

FIG. 2 shows, in accordance with one or more embodiments of the invention, the use of the existing ceramic layer on a typical ESC chuck as the piezoelectric transducer in order to provide the aforementioned acoustic energy to the target substrate.

FIG. 3 shows, in accordance with one or more embodiments of the invention, the use of pressure or sound wave manipulation of a fluid transmission medium in order to provide the aforementioned acoustic energy to the target.

FIG. 4 illustrates, in accordance with one or more embodiments of the invention, an example implementation whereby gas pulsing is employed to impart acoustic energy onto the target.

FIG. 5 shows, in accordance with one or more embodiments of the invention, the use of mechanical motion via a transmission rod or shaft in order to provide the aforementioned acoustic energy arrangement, directly or indirectly via one or more intermediate components, to the target.

FIG. 6 shows, in accordance with one or more embodiments of the invention, an example implementation whereby gas pulsing from a gas feed provided through the top of the chamber or through the chamber sidewalls is employed to impart acoustic energy onto the target.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the invention relate to methods and apparatus for using acoustic energy to improve etch processes and/or to induce other beneficial effects on the wafer and/or chamber components (such as reduced polymer deposition on substrate surface and/or chamber components). As the term is employed herein, acoustic energy refers to energy delivered in the form of vibration or oscillation of a target (such as a substrate or a chamber electrode or a chamber component) irrespective whether the target is directly coupled to the acoustic energy source or whether the acoustic energy source is delivered through some medium and/or one or more intermediate components.

Within this definition, there is no requirement that acoustic energy (also referred to as vibration energy) has to be in the human-audible range of frequencies. In one or more embodiments, acoustic energy in the frequency range of about 10 Hz to about 500 kHz is applied to the target. In one or more embodiments, acoustic energy in the frequency range of about 5 kHz to about 100 KHz is applied to the target. In one or more embodiments, acoustic energy in the frequency range of about 10 kHz to about 50 kHz is applied to the target. These applied acoustic energy frequencies are believed to be beneficial to achieve desired process results and/or induce other beneficial effects on the wafer and/or chamber components. The techniques described here also apply to frequencies approaching and exceeding 1 MHz.

In one or more embodiments, acoustic energy is employed to add to or to alter the energy equation while processing a substrate using plasma. In the same manner that reactive chemical and ion etching have been shown to combine synergistically to achieve more advantageous etch results (such as improved etch rates) than if either process had been employed individually, the inventors believe that acoustic energy may be able to influence the plasma process when employed in combination with reactive chemical and/or ion etching. This is a significant realization since it departs from the traditional direction of sonochemistry investigation, which is to influence reaction chemistry and kinetics in an aequeous (fluid in the classic sense such as water or ethanol) environment. In one or more embodiments, the use of acoustic energy provides another control knob to the plasma process, which is highly beneficial in trying to achieve today's highly demanding etch requirements and/or chamber operation parameters.

In one or more embodiments, acoustic energy is added to increase the total amount of energy supplied to the plasma process for plasma substrate processing purposes in order to achieve desired substrate process results without having to increase the RF power. In these embodiments, the total amount of energy input may be increased and desired substrate process results may be achieved without undue RF power-related collateral damage and thermal loading issues.

In one or more embodiments, acoustic energy is employed in place of a portion of the RF energy previously employed in a given recipe in order to achieve the desired substrate process results. By reducing the amount of RF energy required to achieve desired substrate process results, collateral damage risks to the substrate surface and/or to chamber components are advantageously reduced. Furthermore, thermal loading risks and complications are advantageously reduced.

In one or more embodiments, acoustic energy is employed in place of a portion of the RF energy previously employed and also added to increase the total amount of energy supplied to the plasma process in order to achieve desired substrate process results. These embodiments aim to reduce the amount of additional RF energy added to the plasma process while raising the total amount of energy input. Since the additional input energy is a combination of acoustic energy and other form(s) of energy (including for example RF energy), the amount of additional RF energy required to achieve desired substrate process results is kept lower, and collateral damage risks to the substrate surface and/or to chamber components are advantageously reduced. Furthermore, thermal loading risks and complications are advantageously reduced.

In one or more embodiments, acoustic energy is provided to chamber components (such as chamber walls or electrodes) other than the substrate in order to induce beneficial effects on the chamber components during substrate processing. In these embodiments, the goal is not so much (or not solely) to influence the processing on the substrate but to address process-related consequences on chamber components. These beneficial effects may include, for example, reducing polymer deposition, influencing certain chamber cleaning/conditioning parameters, encouraging particle deposition on a specific chamber part to act as a particle trap, providing additional control knobs to influence the longevity; particle deposition, temperature, and/or other parameters, etc.

In the following discussion, the acoustic energy is directed at a target, which may be the substrate or a chamber component. The acoustic energy may be coupled directly from the acoustic energy source, or may be transmitted via one or more intermediate components or medium. The acoustic energy may be provided, directly or indirectly via one or more intermediate components, using piezoelectric transducer, via mechanical vibration or pressure waves transmitted via one or more transmission medium, via gas pulsing, etc. Depending on the desired application, the target may be the backside or front side of a substrate, may be the chuck on which the substrate is disposed, or may be a chamber wall portion or another chamber component.

In one or more embodiments, the acoustic energy is generated using the expansion/contraction property of materials and coupled to the target. For example, piezoelectric transducer(s) may be employed to generate the acoustic energy to be provided to the target. The acoustic energy may be delivered to the target, directly or indirectly via one or more intermediate components, through direct mechanical coupling or through liquid or fluid coupling. As another example, thermal cycling may be employed to generate acoustic energy to be provided to the target.

In one or more embodiments, the acoustic energy is generated using pressure or sound waves and provided to the target. For example, a speaker or a transducer with a vibrating membrane may be employed to generate such acoustic energy. The acoustic energy may be delivered to the target, directly or indirectly via one or more intermediate components, by directed wave bombardment, by pressure oscillation, and/or by perturbation of a fluid transmission medium using for example propeller-like or jet-like perturbations. In one or more embodiments, the acoustic energy is coupled to the target by pulsing a gas medium that is injected into the chamber or toward the target or a component that is coupled with the target.

In one or more embodiments, the acoustic energy is generated using mechanical, electrical, or electromagnetic means. By way of example, an actuator may be employed to generate rotationally oscillating, linearly oscillating, or randomly oscillating motion. The acoustic energy may be provided to the target, directly or indirectly via one or more intermediate components, using mechanical coupling, immersion/liquid coupling or via the use of a rotating eccentric mass or other mechanical arrangements.

The features and advantages of embodiments of the invention may be better understood with reference to the figures and discussions that follow. In the following examples, the substrate is employed as the example target although it should be understood that the target may be the substrate, a portion of the substrate, or any chamber component in the plasma processing chamber. Furthermore, although the acoustic coupling techniques are discussed individually in connection with the figures, combinations of various techniques may be practiced simultaneously in a given plasma processing chamber (such as gas pulsing and membrane vibration) to provide different control knobs for the process and/or to optimize delivery of the acoustic energy.

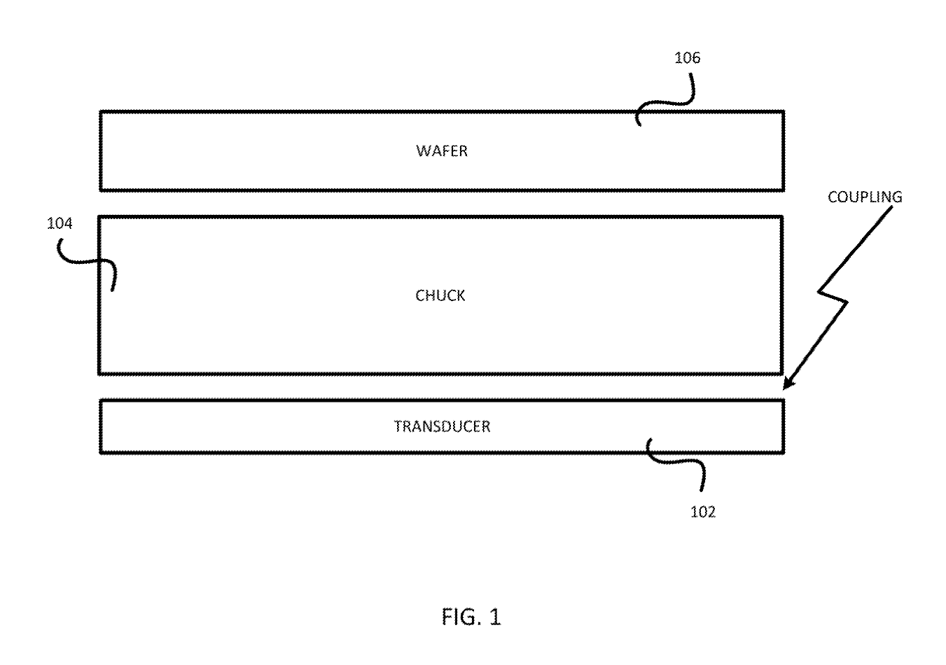

FIG. 1 shows, in accordance with one or more embodiments of the invention, the use of a piezoelectric transducer to provide acoustic energy, directly or indirectly via one or more intermediate components, to the substrate. A piezoelectric transducer is a device that converts electrical pulses into mechanical movement. When a charge is applied across a crystalline material, the polarized molecules align in the direction of the electric field, causing the material to change dimensions along that axis. This can be harnessed to create mechanical vibrations in whatever the transducer is mounted to.

In the embodiment of FIG. 1, a plate 102 having therein one or more piezoelectric transducers is coupled to a chuck 104, representing a work piece holder such as an electrostatic chuck (ESC) or a vacuum chuck or a mechanical chuck. In an embodiment, the transducer(s) in plate 102 may be mechanically coupled to chuck 104 (such as to the chuck base plate, for example) via a mechanical connection such as bolts or screws or springs or an adhesive bond or a combination thereof. The mechanical connection may be chosen for optimal acoustic impedance to tune the acoustic energy delivery to chuck 104, which in turn imparts the acoustic energy to target substrate 106.

Alternatively, the transducer(s) in plate 102 may be coupled to chuck 104 (such as to the chuck base plate, for example) via a fluid medium such as water, distilled water, suitable oil or hydraulic fluid or any other fluid, including liquid and/or gaseous medium. The specific fluid medium and configuration may be chosen for optimal acoustic impedance to tune the acoustic energy delivery to chuck 104, which in turn imparts the acoustic energy to target substrate 106.

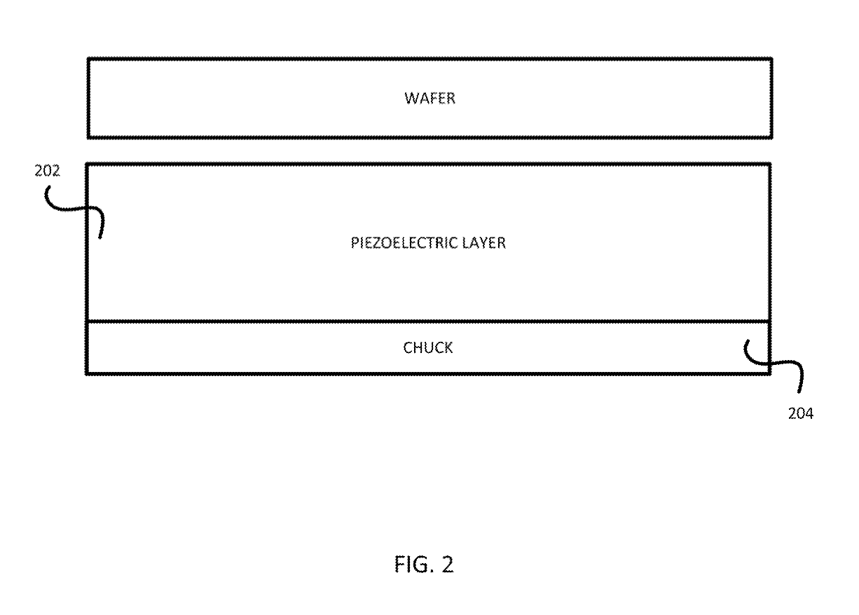

FIG. 2 shows, in accordance with one or more embodiments of the invention, the use of the existing ceramic layer on a typical ESC chuck as the piezoelectric transducer in order to provide the aforementioned acoustic energy to the target substrate. In the example of FIG. 2, the existing ceramic layer 202 on an ESC chuck 204 may be employed, or may be modified to be employed, as a piezoelectric transducer. For example, aluminum nitride may be a suitable piezoelectric material for use in such an application although other suitable piezoelectric materials may be used. When the ESC dielectric layer, such as its topside ceramic layer, is employed as a piezoelectric transducer, little or no changes need to be made to the existing ESC chuck and/or chamber in order to provide the aforementioned acoustic energy to the process, thereby advantageously reducing the need for expensive infrastructure upgrade.

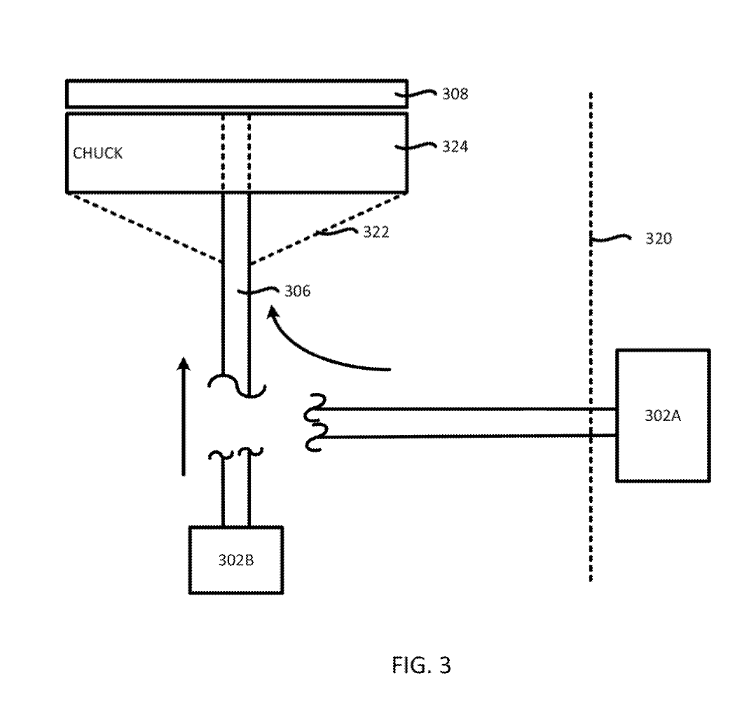

FIG. 3 shows, in accordance with one or more embodiments of the invention, the use of pressure or sound wave manipulation of a fluid transmission medium in order to provide the aforementioned acoustic energy to the target (e.g., the substrate in this example). In the example of FIG. 3, a pressure wave generator 302A and/or 302B generates pressure waves in a fluid (e.g., gaseous or liquid) medium for transmission via fluid conduit 306 in order to provide the acoustic energy to substrate 308. As an example, a speaker or a transducer with a movable membrane to impart a pressure or sound wave on a fluid medium may be employed.

Pressure wave generator 302B represents a generator that is co-linear with conduit 306 while pressure wave generator 302A represents a generator that is non co-linear with conduit 306. The break in the conduit 306 and the depiction of two alternative pressure wave generators illustrate that the generator may be implemented within the chamber environment/enclosure (to the left of line 320) or outside the chamber environment/enclosure (to the right of line 320). The transmission medium in conduit 306 may be gaseous (such as air or another gas) or may be liquid. The exact transmission medium chosen depends on chamber design and the acoustic impedance of the medium.

As seen in FIG. 3, conduit 306 may have a flared end (represented by dotted lines 322) to more evenly apply the acoustic energy to chuck 324 as conduit 306 terminates at the lower surface of chuck 324. Alternatively, conduit 306 may terminate within chuck 324, either at any suitable depth within the thickness of chuck 324 or at the lower surface of the ESC ceramic layer or at the interface between chuck 324 and substrate 308. If conduit 306 is terminated at the lower surface of the ESC ceramic layer or at the interface between chuck 324 and substrate 308, conduit 306 may branch out into multiple branches in order to more evenly apply the acoustic energy to chuck 324 and/or to substrate 308.

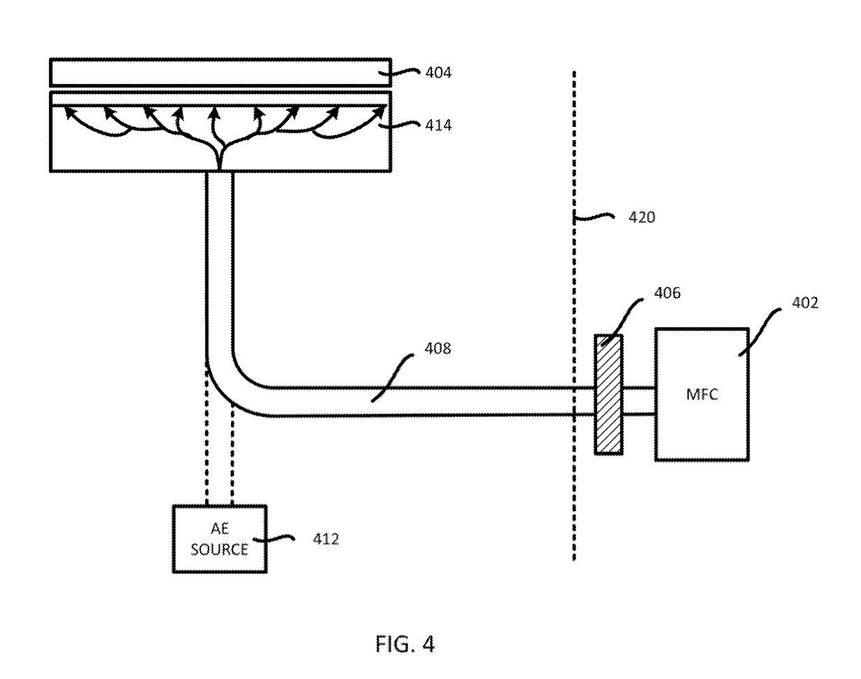

FIG. 4 illustrates, in accordance with one or more embodiments of the invention, an example implementation whereby gas pulsing is employed to impart acoustic energy onto the target. The inventors herein realize that many chucks already have backside cooling arrangements whereby helium or another thermal exchange gas is already piped to the backside of the substrate to control the backside temperature of the substrate. By pulsing such backside cooling gas, acoustic energy can be created and applied to the substrate without requiring extensive modification of the existing plasma processing chamber. If a chuck does not have such backside cooling arrangement already implemented, gas pulsing may also be implemented as discussed herein.

With respect to FIG. 4, a mass flow controller 402 which controls the flow of the gas toward the backside of substrate 404 is shown. Acoustic energy generation may be accomplished by the addition of a fast acting valve 406. Fast acting valve 406, representing the acoustic energy generation mechanism, either partially or fully restricts the flow of gas within conduit 408 in a pulsing fashion at a suitable frequency in order to impart acoustic energy, directly or indirectly via one or more intermediate components, to the target substrate 404.

In an embodiment, an optional pressure wave generator 412 (such as a speaker or another transducer with a movable membrane) may be provided co-linearly with conduit 408 or via a Y-connection (as shown in FIG. 4) in order to, additionally or alternatively instead of fast acting valve 406, impart acoustic energy on the flow of gas toward the backside of substrate 404. Within chuck 414, the gas may fan out in conduit branches (as shown) in order more evenly apply the gas (and the attendant acoustic energy) to substrate 404. One or more of MFC 402, fast acting valve 406, and/or acoustic energy source 412 may be implemented within the chamber environment/enclosure (to the left of line 420) or outside the chamber environment/enclosure (to the right of line 420) depending on spatial availability and other considerations.

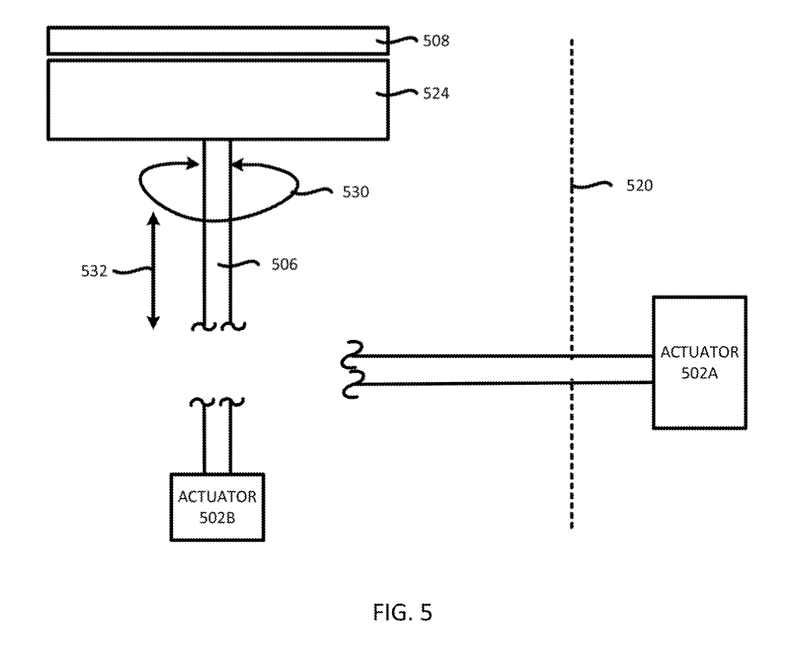

FIG. 5 shows, in accordance with one or more embodiments of the invention, the use of mechanical motion via a transmission rod or shaft in order to provide the aforementioned acoustic energy arrangement, directly or indirectly via one or more intermediate components, to the target (e.g., the substrate in this example). In the example of FIG. 5, a mechanical actuator 502A and/or 502B generates the mechanical motion for transmission via a shaft 506 in order to provide acoustic energy to substrate 508. As an example, a rotational actuator may be employed as the mechanical actuator to provide the aforementioned acoustic energy to chuck 524 or to substrate 508. The rotational actuator may provide an oscillating rotational motion (arrow 530) on shaft 506, or may provide a rotational motion on shaft 506 to be converted to an oscillating rotational or linear motion on chuck 524 via some suitable coupling arrangement such as camming.

Alternatively, a linear actuator may be employed as the mechanical actuator to provide the aforementioned acoustic energy to chuck 524 or to substrate 508. The linear actuator may provide an oscillating linear motion (arrow 532) on shaft 506 to impart the aforementioned acoustic energy on chuck 524 and/or substrate 508. Alternatively, an eccentric mass may be coupled to the motor shaft or to a wheel coupled to the motor shaft in order to impart a vibrating motion as the shaft rotates. The vibrating motion may be transmitted, directly or via one or more intermediate components, to target substrate 508.

Actuator 502B represents an actuator that is co-linear with shaft 506 while actuator 502A represents an actuator that is non co-linear with shaft 506. If the actuator is not co-linear with shaft 506, an appropriate angular coupling or universal coupling may be employed to accommodate the non-linearity.

The break in the shaft 506 and the depiction of two alternative actuators illustrate that the actuator may be implemented within the chamber environment/enclosure (to the left of line 520) or outside the chamber environment/enclosure (to the right of line 520).

In accordance with one or more embodiments of the invention, there is provided a magnetically actuated implementation whereby current flowing through the windings of an inductor coil may be employed to create a magnetic field. The magnetic field would couple to magnetic material to create an electromagnet. By pulsing, changing direction, or otherwise manipulating the current in the inductor coils, magnetically induced oscillation or vibration may be produced.

In one or more embodiments, the inductors or arrays of inductors may be embedded in one chamber part (referred to herein as “the inductor-containing component), while the substrate may be coupled to another chamber part (referred to herein as the substrate-mating component). The magnets may be embedded in the substrate mating component such that there is a corresponding magnet for every inductor. The inductors/magnets may be evenly distributed so that acoustic energy may be evenly applied to the substrate, for example. The arrangement may be radial, concentric, square arrays, etc.

A digital or analog controller or a plurality of controllers may be employed to control the currents through the inductors (e.g., in a pulsing manner in a synchronized or unsynchronized fashion) to induce the vibration or oscillation on the substrate-mating component. To avoid undesired influence on substrate processing, the current magnitude and/or direction may be modulated so that the magnetic lines do not penetrate or only weakly penetrate the substrate disposed above the substrate mating component. The magnetically implemented embodiment is advantageous in that there are no rubbing parts to generate particulate contamination or to induce wear. The substrate-mating component and the inductor-containing component may be kept apart magnetically in the same manner that magnetic forces on a magnetically levitated train keeps the train off the track.

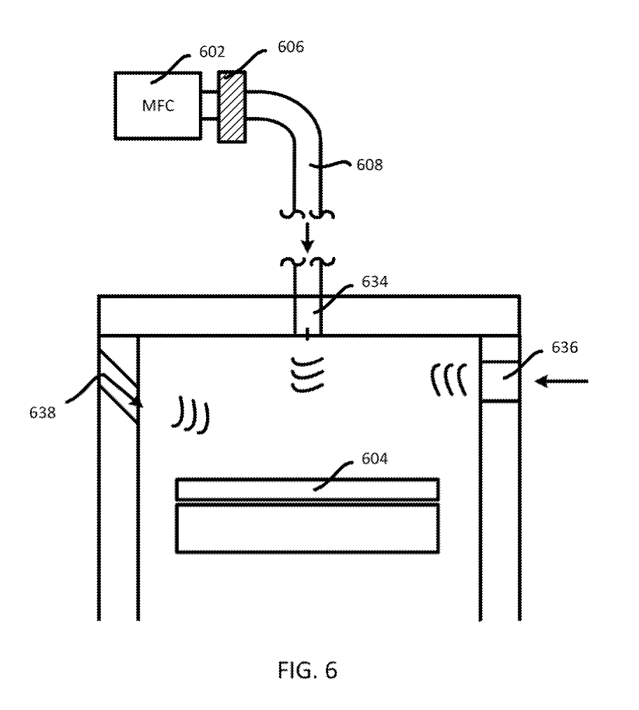

FIG. 6 shows, in accordance with one or more embodiments of the invention, an example implementation whereby gas pulsing from a gas feed provided through the top of the chamber or through the chamber sidewalls is employed to impart acoustic energy onto the target. The inventors herein realize that many plasma processing systems already have reactant or tuning gas feeds through the top of the chamber or through the chamber sidewalls. By pulsing such gas, acoustic energy can be created and applied to the substrate without requiring extensive modification of the existing plasma processing chamber. If a plasma processing chamber does not have such gas conduit through the top side or the side wall of the chamber, gas pulsing may also be implemented as discussed herein.

With respect to FIG. 6, a mass flow controller 602 which controls the flow of the gas into the chamber through the top side (634) and/or through the side (636 or 638) may be pulsed by a fast acting valve 606. These feeds 634, 636, and 638 may be pulsed together or individually in one or more embodiments such that one may be pulsed while the other is not pulsed. Further, some chambers may have only one of feeds 634, 636, and 638 while other chambers may have multiple feeds. Fast acting valve 606, representing the acoustic energy generation mechanism, either partially or fully restricts the flow of gas within conduit 608 in a pulsing fashion in order to impart acoustic energy to the target substrate 604 (through the top side (634) and/or through the side (636 or 638)).

Although the discussion so far has focused on the'examples and implementations to reduce the need for high RF power, the use of acoustic energy in a plasma processing environment also has other applications. Some alternative applications are discussed below.

For example, it is contemplated that providing acoustic energy to the plasma chamber environment may affect reaction kinetics of adsorbed species. It is contemplated that, for example, providing acoustic energy while chemical reactions take place on the wafer surface may affect key etch parameters such as selectivity, etch rate, formation of undesired compounds, rate constants of chemical reactions, and others. The application of acoustic energy can be optimized to reduce the formation and deposition of undesired species in some instances. In this case, the use of acoustic energy can provide an additional control knob for affecting the reaction kinetics of adsorbed species.

As another example, it is contemplated that providing acoustic energy to the plasma chamber environment may suppress chemical bonding. To elaborate, a large percentage of the cost of semiconductor production is driven by system downtime. This in turn is driven in large measure in etch systems by the need for regular periodic chamber cleaning. A significant cause of the need for chamber cleaning is the deposition of undesired chemical species. It is contemplated that, for example, providing acoustic energy may suppress the formation and deposition of undesired species, which in turn reduces the need for regular periodic cleaning as well as provide another control knob to the process.

As another example, it is contemplated that providing acoustic energy to the plasma chamber environment may accelerate ablation. To elaborate, ultimately, etching requires volatile species to be formed and leave the wafer surface. It is contemplated that, for example, providing acoustic energy may accelerate the formation and removal of reactant products, thereby increasing the etch rate. Also, slowing the removal of desired species can enhance etch selectivity and rate. In this case, the use of acoustic energy can provide an additional control knob for ablation acceleration.

As another example, it is contemplated that providing acoustic energy to the plasma chamber environment may affect surface transport of adsorbed species/enhance mass transport inside etch trench. To elaborate, during the etch process, atoms and materials stick to the wafer surface through different mechanisms. They migrate, agglomerate, react, stick, and leave the wafer surface on the surface. Controlling these processes is difficult or impossible in most instances. It is contemplated that coupling acoustic energy with these interactions gives an additional control mechanism to optimize the etch process.

As another example, it is contemplated that providing acoustic energy to the plasma chamber environment may affect the activation of Si atoms. To elaborate, modern etch reactors are approaching 10 KW power to achieve desired results with Si etching. These power levels introduce a host of challenges. Using alternate means of energy delivery such as acoustic energy to the wafer offers a range of advantages and may reduce the need for higher and higher levels of RF energy. In this case, the use of acoustic energy can provide an additional control knob for Si atoms activation.

As another example, it is contemplated that providing acoustic energy to the plasma chamber environment may modify the structure of the adsorbed species. To elaborate, etch selectivity, etch rate, cleaning frequency, CD uniformity, chamber power levels, and other key etch parameters are affected by the chemistry and adsorption of atoms on the wafer surface. It is contemplated that, for example, providing acoustic energy may affect and ultimately enhance these parameters to advantage. In this case, the use of acoustic energy can provide an additional control knob for modifying the structure of the adsorbed species.

As another example, it is contemplated that providing acoustic energy to the plasma chamber environment may dislodge undesired species. To elaborate, etch selectivity, etch rate, cleaning frequency, CD uniformity, chamber power levels, and other key etch parameters are affected by the chemistry and adsorption of atoms on the wafer surface. It is contemplated that, for example, providing acoustic energy may affect and ultimately enhance these parameters to advantage. In this case, the use of acoustic energy can provide an additional control knob for dislodging undesired species.

As another example, it is contemplated that providing acoustic energy to the plasma chamber environment may accelerate desired reactions. To elaborate, etch selectivity, etch rate, cleaning frequency, CD uniformity, chamber power levels, and other key etch parameters are affected by the chemistry and adsorption of atoms on the wafer surface. It is contemplated that, for example, providing acoustic energy may affect and ultimately enhance these parameters to advantage. In this case, the use of acoustic energy can provide an additional control knob for accelerating desired reactions.

As another example, it is contemplated that providing acoustic energy to the plasma chamber environment may affect sidewall adsorption. To elaborate, etch selectivity, etch rate, cleaning frequency, CD uniformity, chamber power levels; and other key etch parameters are affected by the chemistry and adsorption of atoms on chamber sidewalls. It is contemplated that, for example, providing acoustic energy may affect and ultimately enhance control of sidewall deposition rate and chemistry. In this case, the use of acoustic energy can provide an additional control knob for affecting sidewall adsorption.

As another example, it is contemplated that providing acoustic energy to the plasma chamber environment may reduce sidewall damage. To elaborate, etch selectivity, etch rate, cleaning frequency, CD uniformity, chamber power levels, and other key etch parameters are affected by the chemistry and adsorption of atoms on chamber sidewalls. It is contemplated that, for example, providing acoustic energy may affect and ultimately enhance control of sidewall deposition rate and chemistry. In this case, the use of acoustic energy can provide an additional control knob for reducing sidewall damage.

Although some embodiments have been described using the apparatus, the invention also covers methods for making and/or operating the apparatus in its various embodiments. While different features or techniques may be discussed in different embodiments for ease of understanding, there is no implication that these features or techniques are mutually exclusive in all cases. Although it is permissible that a chamber may have only one of the disclosed features, different combinations of features disclosed in various embodiments herein may be combined in a single chamber or in a plasma processing system to advantageously improve plasma processing. Furthermore, any combination of techniques or technique steps may be employed to improve substrate processing and/or chamber longevity and/or throughput and/or efficiency.

While this invention has been described in terms of several preferred embodiments, there are alterations, permutations, and equivalents, which fall within the scope of this invention. Although various examples are provided herein, it is intended that these examples be illustrative and not limiting with respect to the invention. Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A plasma processing system having a plasma processing chamber for processing a substrate using plasma, comprising:
a process gas supply arrangement for supplying a process gas into an interior region of said chamber;
a plasma source configured for generating said plasma at least from said process gas; and
an acoustic energy generator arrangement configured to apply acoustic energy to at least one of a chamber component and said substrate, wherein said acoustic energy generator generates said acoustic energy in the range of 10 Hz to 1 MHz using at least one of a piezoelectric transducing, mechanical coupling vibration, water backside gas pulsing, pulsing of said process gas, pressure wave pulsing, and electromagnetic coupling.

8. The plasma processing system of claim 1 wherein said acoustic energy generator generates said acoustic energy using said piezoelectric transducing.

3. The plasma processing system of claim 2 wherein said piezoelectric transducing utilizes a piezoelectric layer formed as part of a substrate supporting chuck.

4. The plasma processing system of claim 1 wherein said acoustic energy generator generates said acoustic energy using said mechanical coupling vibration.

5. The plasma processing system of claim 1 wherein said acoustic energy generator generates said acoustic energy using said wafer backside gas pulsing.

6. The plasma processing system of claim 1 wherein said acoustic energy generator generates said acoustic energy using said pulsing of said process gas.

7. The plasma processing system of claim 1 wherein said acoustic energy generator generates said acoustic energy using said pressure wave pulsing.

8. The plasma processing system of claim 1 wherein said acoustic energy generator generates said acoustic energy using said electromagnetic coupling.

9. The plasma processing system of claim 1 wherein said acoustic energy is in the range of about 10 Hz to about 1 MHz.

10. The plasma processing system of claim 1 wherein said acoustic energy is in the range of about 5 kHz to about 100 kHz.

11. The plasma processing system of claim 1 wherein said acoustic energy is in the range of about 10 kHz to about 50 kHz.

12. The plasma processing system of claim 1 wherein said acoustic energy is applied to said substrate.

13. The plasma processing system of claim 1 wherein said acoustic energy is applied to said chamber component.

14. The plasma processing system of claim 13 wherein said chamber component is other than a substrate supporting chuck.

15. (canceled)

16. (canceled)

17. (canceled)

18. (canceled)

19. (canceled)

20. (canceled)

21. (canceled)

22. (canceled)

23. A plasma processing system having a plasma processing, chamber for processing a substrate using plasma, said plasma processing chamber comprising:
a substrate supporting chuck configured for supporting said substrate during said processing;
a plasma source configured for generating said plasma from process gas; and
an acoustic energy generator arrangement configured to apply acoustic energy to at least one of a chamber component and said substrate, wherein said acoustic energy generator generates said acoustic energy in the range of 10 Hz to 1 MHz using at least one of a piezoelectric transducing, mechanical coupling vibration, and electromagnetic coupling.

24. The plasma processing system of claim 23 wherein said acoustic energy is generated via said piezoelectric transducing and applied indirectly to said substrate via at least one intermediate component.

25. The plasma processing system of claim 23 wherein said acoustic energy is generated via said piezoelectric transducing and in the range of about 10 Hz to about 1 MHz.

26. The plasma processing system of claim 23 wherein said acoustic energy is generated via said piezoelectric transducing and in the range of about 5 kHz to about 100 kHz.

27. The plasma processing system of claim 23 wherein said acoustic energy is generated via said piezoelectric transducing and in the range of about 10 kHz to about 50 kHz.

28. The plasma processing system of claim 23 wherein said acoustic energy is generated via said piezoelectric transducing and applied to said chamber component.

29. The plasma processing system of claim 28 wherein said chamber component is generated via said piezoelectric transducing and other than said substrate supporting chuck.
